(19) United States
(12) Patent Application Publication
(10) Pub. No.: US 2026/0218773 A1
(43) Pub. Date: Jul. 30, 2026

(54) HYDRAULIC DAMPER

(71) Applicant: BeijingWest Industries Co., Ltd., Beijing (CN)

(72) Inventors: Dominik KASPRZYK, Krakow (PL); Karol KOZUBEK, Balice (PL)

(21) Appl. No.: 19/195,657

(22) Filed: Apr. 30, 2025

(30) Foreign Application Priority Data
Jan. 27, 2025 (CN) 202510127517.5

(51) Int. Cl. F16F 9/49; B60G 13/08; B60G 17/08; F16F 9/18; F16F 9/348

(52) U.S. Cl. CPC F16F 9/49; F16F 9/185; F16F 9/348; B60G 13/08; B60G 17/08; B60G 2202/24; B60G 2204/62; B60G 2206/41; B60G 2500/114; B60G 2600/21; B60G 2800/162; B60G 2800/916; F16F 2222/12; F16F 2228/066; F16F 2230/007; F16F 2230/02; F16F 2230/42; F16F 2234/02

(57) ABSTRACT

A damper assembly with a hydraulic compression stop (HCS) includes a tube defining an interior chamber. The damper assembly also includes a piston assembly slidably disposed in the tube. The piston assembly includes an HCS piston and a safety valve assembly disposed on top of a base valve. The safety valve assembly includes one or more deflective discs configured to deflect in response to a force applied to the piston rod exceeding a predetermined threshold, the deflection of the discs enables a second flow of working fluid from the HCS to the base valve assembly thereby reducing the forces applied to the HCS.

### CROSS-REFERENCE TO RELATED APPLICATIONS

This application claims priority to Chinese Patent Application No. 202510127517.5 filed on Jan. 27, 2025, which is hereby incorporated by reference in its entirety.

### TECHNICAL FIELD

The present disclosure relates to a hydraulic damper, in particular a motor vehicle suspension damper.

### BACKGROUND

Certain vehicles include suspension systems provided with one or more hydraulic dampers. Hydraulic dampers may include a hydraulic compression stop assembly for generating an additional damping force over a predefined section of the piston rod travel during a compression stroke.

### SUMMARY

The present disclosure relates to a hydraulic damper for use in a vehicle. The hydraulic damper may include a main tube, an external tube, a main piston assembly, a base valve assembly, and a hydraulic compression stop assembly. The main tube may be filled with a hydraulic fluid and the external tube may extend about the main tube to define a compensation chamber. The main piston assembly may be disposed in the main tube and may divide the main tube into a rebound chamber and a compression chamber. The base valve assembly may be located at an end of the compression chamber to control a flow of working fluid passing between the compression chamber and the compensation chamber. The hydraulic compression stop assembly may be disposed in the compression chamber and may include a safety valve assembly, a sleeve, and an additional piston assembly. The safety valve assembly may include a plurality of deflective discs and an adapter member. The safety valve assembly may be configured to change between a disengaged state and an engaged state. The sleeve may be fixed on the adapter member and configured to allow the flow of working fluid between the sleeve and the main tube through the base valve assembly, and the sleeve may define an inner chamber. The additional piston assembly may be displaceable along with the main piston assembly and apt to be introduced inside the inner chamber of the insert at an end of a hydraulic damper compression stroke to generate additional damping force, wherein the additional damping force is associated with a pressure applied to the safety valve assembly. In response to the associated pressure being below a predetermined threshold, the safety valve assembly may be in the disengaged state, in which the plurality of deflective discs are not deflected to enable a first flow of working fluid from the inner chamber to the compression chamber, and an engaged state in which the plurality of deflective discs are deflected to enable a second flow of working fluid from the safety valve assembly to the base valve assembly.

The adapter member may define an aperture configured to communicate a flow of working fluid from the compression chamber to the plurality of deflective discs.

The safety valve assembly may include a plurality of spacers disposed between the base valve assembly and the plurality of deflective discs.

According to another aspect of this disclosure, a hydraulic damper is provided. The hydraulic damper may include a main tube, an external tube, a main piston assembly, a base valve assembly, and a hydraulic compression stop assembly. The main tube may be filled with a working fluid and the external tube may extend about the main tube and may define a compensation chamber. The main piston assembly may include a main piston rod and may be slidably disposed inside the main tube and may divide the main tube into a rebound chamber and a compression chamber. The base valve assembly may be located at an end of the compression chamber and configured to control the flow of working fluid passing between the compression chamber and the compensation chamber and the hydraulic compression stop assembly may be disposed in the compression chamber and the hydraulic compression stop assembly may include a safety valve assembly, a sleeve, and an additional piston assembly. The additional piston assembly may include an additional piston rod, a piston ring, and a fastener, the fastener may be configured to fix the piston ring to the additional piston rod. The additional piston assembly may be displaceable along with the main piston assembly and may be configured to be introduced inside the inner chamber of the insert at an end of a hydraulic damper compression stroke to generate an additional damping force. The additional damping force may be associated with a pressure applied to the safety valve assembly. In response to the associated pressure being below a predetermined threshold, the safety valve assembly is in the disengaged state to enable a first flow of working fluid between the additional piston assembly and the inner chamber, and in response to the associated pressure rising above the predetermined threshold, the safety valve assembly is in the engaged state to enable a second flow of working fluid to flow from the safety valve assembly to the base valve assembly.

According to yet another aspect of this disclosure, a hydraulic damper for use in a vehicle is provided. The hydraulic damper may include a main tube, an external tube, a main piston assembly, a base valve assembly, and a hydraulic compression stop assembly. The main tube may be filled with a working fluid and the external tube may extend about the main tube and may define a compensation chamber. The main piston assembly may include a main piston rod and may be slidably disposed inside the main tube and may divide the main tube into a rebound chamber and a compression chamber. The hydraulic compression stop assembly may be located at an end of the compression chamber and may include a safety valve assembly, a sleeve, and an additional piston assembly. The safety valve assembly may be configured to change between a disengaged state and an engaged state, the safety valve assembly may include a plurality of deflective discs that may be configured to deflect to change a state of the safety valve assembly from the disengaged state to the engaged state. The additional piston assembly may include an additional piston rod, a piston ring, and a fastener. The fastener may be configured to fix the piston ring to the additional piston rod. The additional piston assembly may be displaceable along with the main piston assembly and apt to be introduced inside the chamber of the insert at the end of a hydraulic damper compression stroke to generate an additional damping force. Pressure applied to the safety valve assembly may be based on the additional damping force. In response to the associated pressure being below a predetermined threshold, the safety valve may be in the disengaged state to enable a first flow of working fluid between the additional piston assembly and the inner chamber. And in response to the associated pressure rising above the predetermined threshold, the safety valve assembly may in an engaged state to enable a second flow of working fluid to flow from the safety valve assembly to the base valve assembly.

### BRIEF DESCRIPTION OF THE DRAWINGS

FIG. 1 illustrates a fragment of a vehicle suspension comprising the damper according to one or more embodiments of the present disclosure.

FIG. 2 is a schematic cross-sectional view of an embodiment of a twin-tube damper according to the present invention with an embodiment of a hydraulic compression stop assembly.

FIG. 2A is a detail view taken along lines 2A in FIG. 2.

FIG. 3 illustrates a perspective view of a sleeve of the hydraulic compression stop assembly.

FIG. 4 illustrates an exploded-perspective view of the additional piston assembly according to one or more embodiments.

FIG. 5 illustrates an exploded-cross-sectional view of a safety valve assembly and base valve assembly of the hydraulic compression stop assembly.

FIG. 6 illustrates a schematic cross-sectional view of the additional piston assembly and the hydraulic compression stop assembly in which a safety valve assembly is in a disengaged state.

FIG. 7 illustrates a schematic cross-sectional view of the additional piston assembly and the hydraulic compression stop assembly in which the safety valve assembly is in an engaged state.

FIG. 7A illustrates a detail view taken along the lines 7A in FIG. 7.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This invention is not limited to the specific embodiments and methods described below, as specific components and/or conditions may, of course, vary. Furthermore, the terminology used herein is used only for the purpose of describing particular embodiments of the present invention and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially” or “about” may be used herein to describe disclosed or claimed embodiments. The term “substantially” or “about” may modify a value or relative characteristic disclosed or claimed in the present disclosure. In such instances, “substantially” or “about” may signify that the value or relative characteristic it modifies is within ±0%, 0.1%, 0.5%, 1%, 2%, 3%, 4%, 5% or 10% of the value or relative characteristic.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). The term “and/or” includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Damper assemblies are well known in the art for use in a vehicle. Vehicle suspension systems are designed to absorb the shock caused by uneven driving surfaces. Damper assemblies assist the suspension system by capturing vibrations between the wheels and the vehicle body. Dampers typically work in tandem with a spring, where the damper absorbs the excess force, the spring may transfer to the vehicle body. On bumpy roads, especially on a curve, the vibrations of the vehicle body become serious enough to cause a driver to lose control of the vehicle. The damper assemblies dampen out the mainspring oscillations once the wheel has passed the bumpy area. The spring energy is converted to heat and dissipated by the dampers. Early dampers were merely cylinders filled with oil or gas; damper designs have improved since.

In some designs, a damper assembly may provide enhanced damping properties using a hydraulic compression stop arrangement that generates additional damping force over a predefined end section of an operating travel range of the piston rod. Exemplary dampers provided with such hydraulic compression stop arrangements are disclosed in patent publications. The hydraulic compression stop arrangements permit progressive generation of additional damping force depending not only on a piston assembly position but also on its velocity within the predefined end section, which may be tunable.

However, such hydraulic compression stop arrangements may limit piston stroke length by using space within a damper that would otherwise be available for piston stroke.

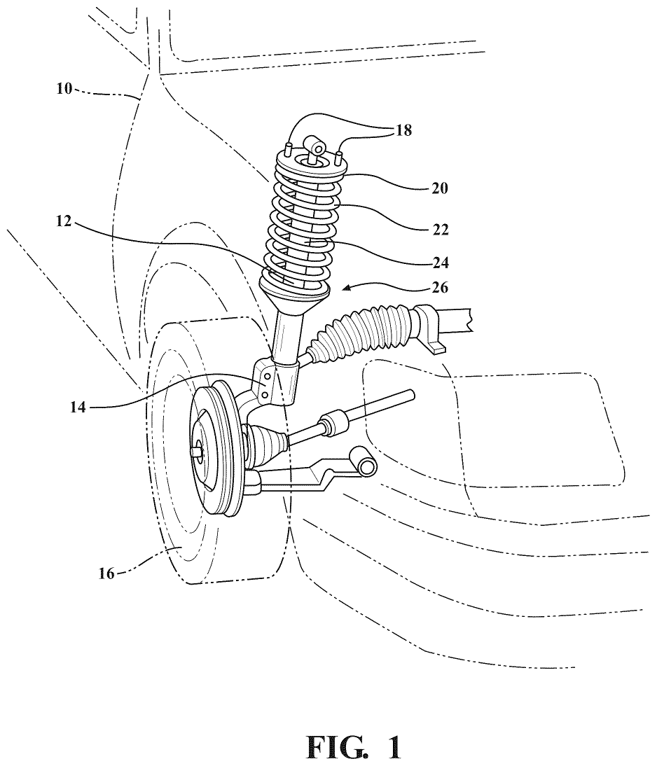

FIG. 1 schematically illustrates a fragment of an exemplary vehicle suspension comprising a damper 26 of the present disclosure attached to a vehicle chassis 10 by means of a top mount 20 and a number of screws 18 disposed on the periphery of the upper surface of the top mount 20. The top mount 20 is connected to a coil spring 22 and a piston rod 24 of the damper 26. The tube 12 of the damper 26 is connected to the steering knuckle 14 supporting the vehicle wheel 16.

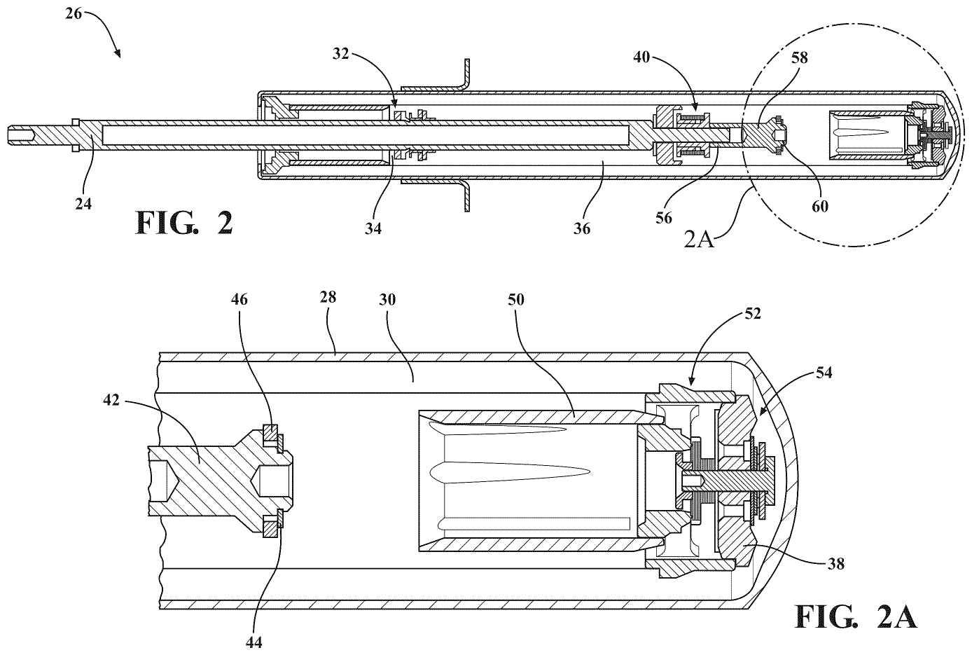

FIG. 2 shows an embodiment of a twin-tube damper 26 according to the present disclosure and FIG. 2A shows a detail view taken along lines 2A in FIG. 2. The damper 26 may include an external tube 28 and a main tube 30 filled with a viscous working liquid inside of which a first or main moveable rebound stop 32 attached to a main piston rod 24 led outside the damper 26 through a sealed piston guide is disposed. The damper 26 is also provided with a base valve assembly 54 fixed at the other end of the main tube 30. The rebound stop 32 makes a sliding fit with the inner surface of the main tube 30 and divides the tube 30 into a rebound chamber 34 and a rebound chamber 36. An additional compensation chamber 38 is located at the other side of the base valve assembly 54.

The damper 26 is further provided with a hydraulic compression stop assembly (HCS) 48 located in the rebound chamber 36 to generate an additional damping force at the end of the compression stroke e.g. in order to avoid abrupt stop of the rebound stop 32. The main components of the HCS 48 may include a sleeve 50, adaptor 52, and piston assembly 40. As shown in FIG. 4, the piston assembly 40 may include a second piston rod 42, a piston ring 46, and a fastener (e.g., snap ring 44) configured to fix the piston ring 46 to the second piston rod 42. The second piston rod 42 may include a proximal end portion 56, a distal end portion 60 and a medial portion 58 extending between the proximal end portion 56 and the distal end portion 60. The proximal end portion 56 may define an aperture configured to receive a portion of the main piston rod 24 as the second piston assembly 40 moves with rebound stop 32.

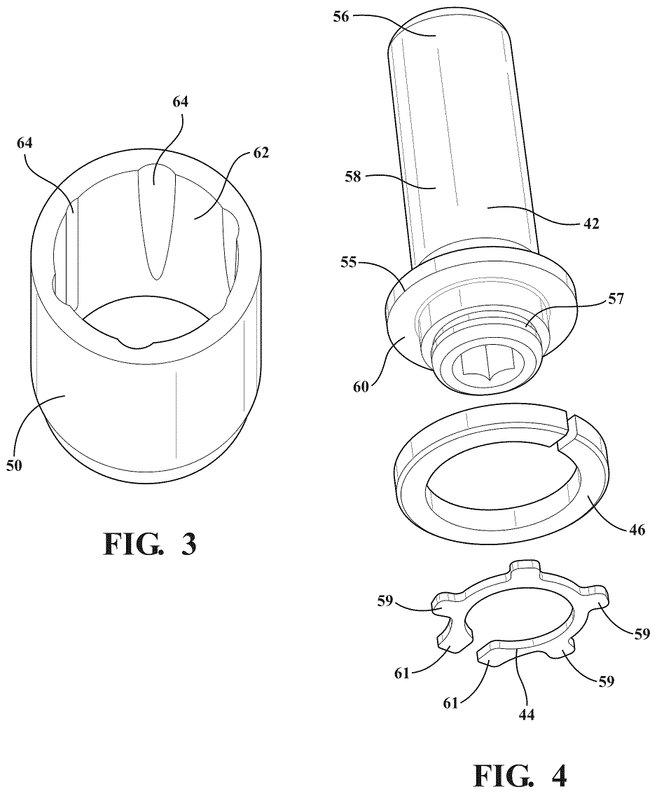

FIG. 3 illustrates a perspective view of the sleeve 50 which may have a simple cylindrical shape and may be made of metal by cold drawing. As will be described in greater detail below, the sleeve 50 includes an inner periphery 62 that may define one or more grooves 64 configured to facilitate the flow of working fluid from one end of the sleeve 50 to another end of the sleeve 50.

FIG. 4 illustrates an exploded-perspective view of the piston assembly 40 according to one or more embodiments. As mentioned above, the piston assembly 40 includes the second piston rod 42, a piston ring 46, and a fastener (e.g., snap ring 44) configured to fix the piston ring 46 to the second piston rod 42. The piston rod 42 includes a proximal end portion 56, a distal end portion 60, and a medial portion 58 extending therebetween. The distal end portion 60 may include a flange 55 and groove 57 that may be disposed further away from the distal end portion 60 than the flange 55. The piston ring 46 may be seated on the flange 55 and the snap ring 44 may be inserted into the groove 57 to fix the piston ring 46 to the second piston rod 42 (e.g., on the flange 55). The snap ring may include one or more tabs 59 extending from a main body of the snap ring 44 and the main body may include opposing ends with end portion tabs 61 that may be spaced apart from one another so that the snap ring 44 may be inserted into the groove 57.

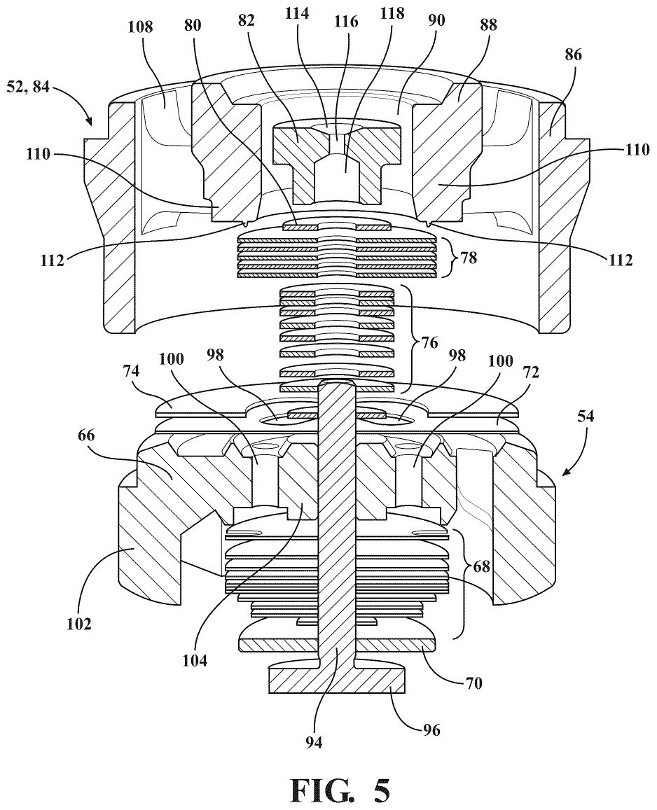

FIG. 5 illustrates an exploded-cross-sectional view of adaptor 52 and the base valve assembly 54 of the HCS 48. The base valve assembly 54 may include a base valve adapter 66, a bottom spacer 70, one or more discs, and a base valve top plate 72. The base valve adapter 66 may include an outer portion 102 and a central portion 104 that may be recessed or spaced apart from the outer portion 102. The central portion 104 may define an aperture that is configured to receive a fastener 94. One or more (e.g., two) fluid passages 100 may be defined by the central portion 104 and disposed on either side of the fastener 94.

A plurality of base valve discs 68 and a base valve spacer 70 may be centrally aligned by the fastener 94 so that the base valve discs 68 and the spacer 70 are aligned with the central portion 104 of the base valve adapter 66. The base valve top plate 72 may be disposed on top of the base valve adapter 66 and one or more fluid passages 98 may be defined in the base valve top plate 72. The fluid passages 98 formed in the top plate 72 and the fluid passages 100 formed in the base valve adapter 66 may be configured to receive working fluid from the safety valve assembly 52 and provide the working fluid to the compensation chamber 38 (FIG. 2A).

The safety valve assembly 52 may include a safety valve adapter member 84, one or more safety valve spacers 76, a top spacer 80, one or more deflective discs 78, an intake member 82, and a safety valve bottom plate 74. The safety valve adapter member 84 may include a first cylindrical portion 86 and a second cylindrical portion 88 that may circumferentially surround the first cylindrical portion 86. An upper portion of the first and second cylindrical portions 86, 88 may be spaced apart from one another to form a gap 108 that may receive an end portion of the sleeve 50. In one or more embodiments, a bottom portion 110 of the first cylindrical portion 86 may include one or more protrusions 112 that may be configured to engage and deflect the one or more deflective discs 78 in response to a pressure applied to the safety valve assembly 52 exceeding a predetermined threshold.

The one or more safety valve spacers 76 may be disposed between the safety valve bottom plate 74 and the one or more deflective discs 78 to separate the base valve assembly 54 from the safety valve assembly 52. The one or more safety valve spacers 76 may also be configured to apply a preload force to the one or more deflective discs 78. A top spacer 80 and an intake member fastener 82 (e.g., a nut) may be disposed in a central aperture 90 defined by the first cylindrical portion. The intake member fastener 82 may define an aperture 114 and a fluid passage provided with a first portion 116 and a second portion 118 extending from the aperture 114. The first portion 116 of the fluid passage may be narrower than the second portion 118 and the first and second portions 116, 118 may communicate working fluid from the center aperture 90 to the deflective discs 78.

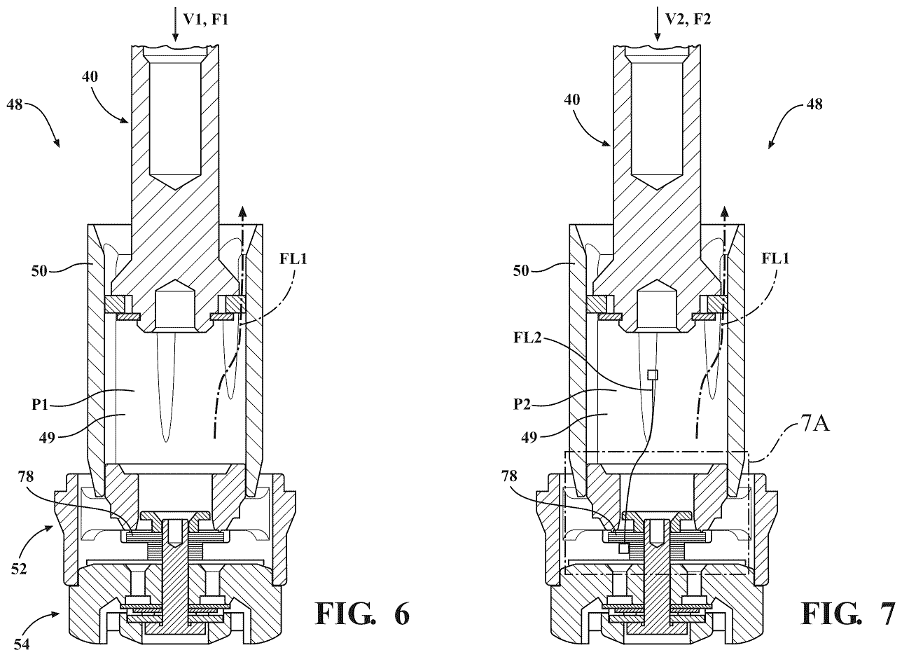

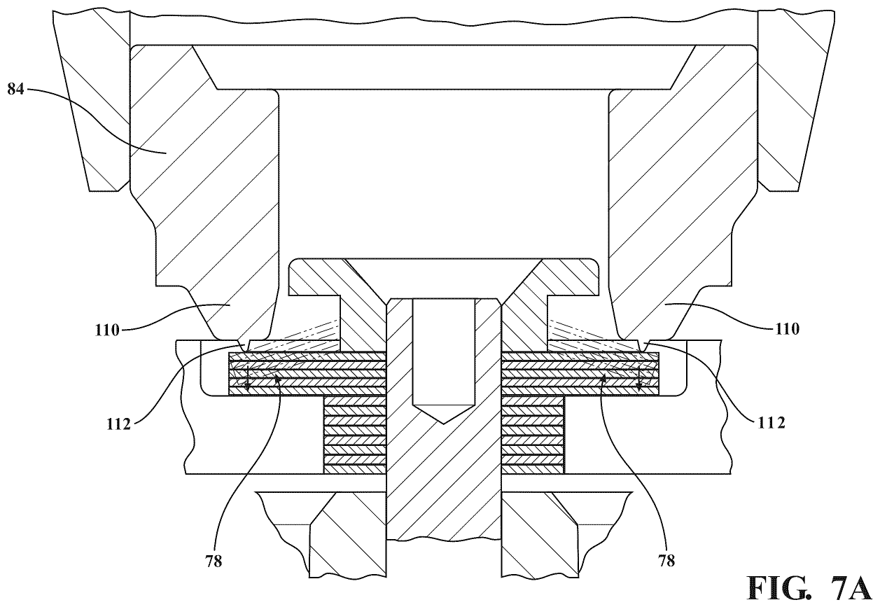

FIG. 6 illustrates a schematic cross-sectional view of the piston assembly 40 and the hydraulic compression stop assembly 48 in which a safety valve 52 is in a disengaged state. FIG. 7 illustrates a schematic cross-sectional view of the additional piston assembly 40 and the hydraulic compression stop assembly 48 in which the safety valve 52 is in an engaged state. FIG. 7A illustrates a detail view taken along the lines 7A in FIG. 7.

As shown in FIG. 6, a first force F1 is applied to the second piston assembly 40 at a first velocity V1. The force F1 may be less than a predetermined threshold (e.g., 1,000 N) applied at a velocity of approximately 0.5 m/s, and the working fluid within a chamber 49 defined by the sleeve 50 may reach a first pressure P1 that may be insufficient to deflect the one or more deflective discs 78. Because the one or more deflective discs 78 are not deflected, some of the working fluid disposed in the chamber 49 may flow through the grooves 64 and into the compression chamber (FIG. 2) as represented by the directional arrow FL1.

As shown in FIG. 7 and FIG. 7A, a second force F2 may be applied to the piston assembly 40 at a second velocity V2. The force F2 may be greater than a predetermined threshold (e.g., 1,000 N) applied at a velocity of approximately 0.5 m/s or 1.0 m/s, and the working fluid disposed within the chamber 49 may reach a second pressure P2 that is sufficient to deflect the one or more deflective discs 78 (as represented by the dashed lines in FIG. 7A). As one example, the pressure P2 applies a force to the adapter member 84 and the protrusions 112 formed on the base of the adapter member 84 may apply a force to the deflective discs 78 to enable a second flow of working fluid (as represented by the directional arrow FL2) to travel through a gap formed between the deflective discs 78 and one or more portions of the safety valve assembly 52 (e.g., the intake member 82) to the base valve assembly 54. The second flow FL2 of fluid may reduce the pressure P2 within the chamber and reduce the forces applied to the second piston rod 42 and inhibit possible damage to other components of the vehicle suspension system and vehicle chassis.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A hydraulic damper comprising:
a main tube filled with a working fluid;
an external tube extending about the main tube and defining a compensation chamber;
a main piston assembly slidably disposed in the main tube and dividing the main tube into a rebound chamber and a compression chamber;
a base valve assembly located at an end of the compression chamber to control a flow of working fluid passing between the compression chamber and the compensation chamber; and
a hydraulic compression stop assembly disposed in the compression chamber and including:
a safety valve assembly including a plurality of deflective discs and an adapter member the safety valve assembly configured to change between a disengaged state and an engaged state,
a sleeve fixed on the adapter member and configured to allow the flow of working fluid between the sleeve and the main tube through the base valve assembly, the sleeve defining an inner chamber, and
an additional piston assembly displaceable along with the main piston assembly and apt to be introduced inside the inner chamber of the sleeve at an end of a hydraulic damper compression stroke to generate an additional damping force, wherein the additional damping force is associated with a pressure applied to the safety valve assembly,
wherein in response to the associated pressure being below a predetermined threshold, the safety valve assembly is in the disengaged state, in which the plurality of deflective discs are not deflected to enable a first flow of working fluid from the inner chamber to the compression chamber, and in response to the associated pressure rising above the predetermined threshold, the safety valve assembly is in the engaged state, in which the plurality of deflective discs are deflected to enable a second flow of working fluid from the safety valve assembly to the base valve assembly.

2. The hydraulic damper of claim 1, wherein the adapter member defines an aperture configured to communicate a flow of working fluid from the compression chamber to the plurality of deflective discs.

3. The hydraulic damper of claim 1, wherein the safety valve assembly includes a plurality of spacers disposed between the base valve assembly and the plurality of deflective discs.

4. The hydraulic damper of claim 3, wherein the plurality of spacers are configured to apply a pre-load to the plurality of deflective discs.

5. The hydraulic damper of claim 4, wherein the plurality of spacers are configured to separate the safety valve assembly from the base valve assembly.

6. The hydraulic damper of claim 1, wherein the hydraulic compression stop assembly includes a fastening member provided with a first end and a second end, the first end including a head configured to engage the base valve assembly.

7. The hydraulic damper of claim 6, wherein the hydraulic compression stop assembly includes an intake retainer member, wherein the intake retainer member is fixed to the second end of the fastener member.

8. The hydraulic damper of claim 1, wherein the adapter member includes a first cylindrical portion and a second cylindrical portion, the first cylindrical portion surrounding the second cylindrical portion, the second cylindrical portion defining a central aperture configured to communicate a flow of working fluid from the compression chamber to the plurality of deflective discs.

9. The hydraulic damper of claim 8, wherein the first cylindrical portion is spaced apart from the second cylindrical portion to form a gap, wherein an end region of the sleeve is disposed within the gap.

10. The hydraulic damper of claim 8, wherein a bottom region of the second cylindrical portions defines one or more protrusions, the one or more protrusions configured to engage and deflect the plurality of deflective discs to enable to a second flow of working fluid from the safety valve assembly to the base valve assembly.

11. The hydraulic damper of claim 10, wherein a bottom region of the first cylindrical portion covers at least a portion of the base valve assembly with respect to a radial direction.

12. The hydraulic damper of claim 1, wherein an inner periphery of the sleeve defines one or more grooves configured to facilitate the first and second flows of working fluid.

13. A hydraulic damper comprising:
a main tube filled with a working fluid;
an external tube extending about the main tube and defining a compensation chamber;
a main piston assembly including a main piston rod and slidably disposed inside the main tube and dividing the main tube into a rebound chamber and a compression chamber;
a base valve assembly located at an end of the compression chamber to control a flow of working fluid passing between the compression chamber and the compensation chamber; and
a hydraulic compression stop assembly disposed in the compression chamber and including:
a safety valve assembly configured to change between a disengaged state and an engaged state,
a sleeve fixed on safety valve assembly and configured to allow the flow of fluid between the sleeve and the main tube through the base valve assembly, the sleeve defining an inner chamber, and
an additional piston assembly including an additional piston rod, a piston ring, and a fastener, the fastener fixing the piston ring to the additional piston rod, wherein the additional piston assembly is displaceable along with the main piston assembly and apt to be introduced inside the inner chamber of the sleeve at an end of a hydraulic damper compression stroke to generate an additional damping force, wherein the additional damping force is associated with a pressure applied to the safety valve assembly,
wherein in response to the associated pressure being below a predetermined threshold, the safety valve assembly is in the disengaged state to enable a first flow of working fluid between the additional piston assembly and the inner chamber, and in response to the associated pressure rising above the predetermined threshold, the safety valve is in the engaged state to enable a second flow of working fluid to flow from the safety valve assembly to the base valve assembly.

14. The hydraulic damper of claim 13, wherein the safety valve assembly includes an adapter member and a plurality of deflective discs, wherein when the safety valve assembly is in the engaged state, the plurality of deflective discs are deflected to permit the second flow of working fluid to flow from the safety valve assembly to the base valve assembly.

15. The hydraulic damper of claim 13, wherein the additional piston rod is fixed to the main piston rod.

16. The hydraulic damper of claim 15, wherein the additional piston rod includes a flange, wherein the piston ring is seated on an axial face of the flange, wherein the axial face faces the safety valve assembly.

17. The hydraulic damper of claim 16, wherein the additional piston rod includes a proximal end portion, a medial portion, and a distal end portion, the proximal end portion fixed to the main piston rod, the distal end portion including the flange and a notch, wherein the fastener is a snap ring fixed within the notch and the piston ring is disposed between the flange and the snap ring.

18. A hydraulic damper comprising:
a main tube filled with a working fluid;
an external tube extending about the main tube and defining a compensation chamber;
a main piston assembly including a main piston rod and slidably disposed inside the main tube and dividing the main tube into a rebound chamber and a compression chamber;
a base valve assembly located at an end of the compression chamber to control a flow of working fluid passing between the compression chamber and the compensation chamber; and
a hydraulic compression stop assembly disposed in the compression chamber and including:
a safety valve assembly configured to change between a disengaged state and an engaged state the safety valve assembly include a plurality of deflective discs configured to deflect to change a state of the safety valve assembly from the disengaged state to the engage state,
a sleeve fixed on safety valve assembly and configured to allow the flow of fluid between the sleeve and the main tube through the base valve assembly, the sleeve defining an inner chamber, and
an additional piston assembly including an additional piston rod, a piston ring, and a fastener, the fastener fixing the piston ring to the additional piston rod, wherein the additional piston assembly is displaceable along with the main piston assembly and apt to be introduced inside the inner chamber of the sleeve at an end of a hydraulic damper compression stroke to generate additional damping force, wherein a pressure applied to the safety valve assembly is based on the additional damping force,
wherein in response to the pressure being below a predetermined threshold, the safety valve assembly is in the disengaged state to enable a first flow of working fluid between the additional piston assembly and the inner chamber, and in response to the pressure rising above the predetermined threshold, the safety valve assembly is in an engaged state to enable a second flow of working fluid to flow from the safety valve assembly to the base valve assembly.

19. The hydraulic damper of claim 18, wherein the safety valve assembly further includes a an adapter member and a plurality of spacers, wherein an end portion of the sleeve is disposed on the adapter member, and wherein the plurality of spacers are disposed between the base valve assembly and the plurality of deflective discs.

20. The hydraulic damper of claim 18, wherein the hydraulic compression stop assembly further includes a fastener provided with a head, wherein the base valve assembly is sandwiched between the head of the fastener and the safety valve assembly.
